(19) United States
(12) Patent Application Publication
(10) Pub. No.: US 2003/0050041 A1
(43) Pub. Date: Mar. 13, 2003

(54) Network system for providing prepaid wireless remote access service

(76) Inventor: Robert Wu, Princeton Junction, NJ (US)

Correspondence Address: Allen R. Kipnes, WATOV & KIPNES, P.C., P.O. BOX 247, PRINCETON JUNCTION, NJ, 08550, US

(21) Appl. No.: 09/948,414

(22) Filed: Sep. 7, 2001

(51) Int. Cl. H04M 11/00

(52) U.S. Cl. 455/406; 455/405

(57) ABSTRACT

A network system for providing a customer with a prepaid wireless remote access service where the system comprises a base station including a wireless access point for communicating through a wireless medium with a wireless station operated by a customer, a global communications network including a plurality of remote computer servers, the global communications network being connected to the base station, and a central access server in communication with the base station through the global communications network for providing the customer with the wireless prepaid remote access service from the wireless station to the plurality of remote computer servers.

### FIELD OF THE INVENTION

The present invention relates generally to telecommunications systems, and more particularly, to a network system capable of providing prepaid wireless remote access service.

### BACKGROUND OF THE INVENTION

Technology involving telecommunications and computers have become

increasingly integrated bringing about major changes to the way people communicate. In this regard, people have become increasingly dependent on data and network access for both home and work. Access to data and the networks carrying the data, can be made through available electronic devices including, but not limited to, mobile and personal computers, personal digital assistants, cellular telephones, and the like. In view of the dependency on data access, electronic devices especially portable ones have become indispensable communication tools for sending and receiving data, fax, voice, email, video messages, and the like, to and from almost any point in the world. When away from home or office, people often take their portable electronic devices with them. The main problem faced by users of such portable electronic devices is the limited availability of communications network access in public places such as airports, convention centers, bus terminals, shopping centers, restaurants, arenas, and the like.

Over recent years, the field of wireless communications has enjoyed tremendous growth. Wireless technology now reaches or is capable of reaching nearly every location on the face of the earth. Millions of people exchange information every day using pagers, cellular telephones, and other wireless communication devices. With the tremendous success of wireless telephone and messaging systems, wireless technology has more recently made significant inroads into the area of personal and business computing. Without the constraints imposed by wired networks, network users can move about almost without restriction and access a communications network from nearly any location, enabling transmission of a variety forms of information between network connected computers or stations.

Accordingly, there is a need for a network system to provide customers in public areas with prepaid wireless access to communications networks. The prepaid wireless access allows the customers to maintain connection at any location within a wireless coverage area. In this manner, the customer is not confined to a specific location and may move about within the wireless coverage area without disruption to access or connection with the communications networks. Since the number of connections are not limited by physical connecting ports, a large number of customers can easily be accommodated within the wireless coverage area. There is also a need for a system which provides prepaid access to communications networks over a wide coverage area that is relatively inexpensive and easy to implement.

### SUMMARY OF THE INVENTION

The present invention is generally directed to a network system capable of providing prepaid wireless remote access services. The network system is configured for implementing relatively high bandwidth communications links to customers through a wireless medium at any location within a wireless coverage area. The network system requires minimal space for executing operations, is discretely located, and can operate over a large public area without the physical constraints and limitations of hardwiring, connecting ports, and user interface equipment. The manner in which the network system can be implemented and positioned inconspicuously makes the system especially suited for use in public places with limited space and high traffic throughput such as airports, hotels, cafes, public transportation centers, vehicles, restaurants, libraries, college campuses, and the like.

In the present invention, there is generally provided a base station in communication with one or more wireless stations comprising, for example, portable electronic devices. The base station is responsible for all the wireless stations within a particular wireless coverage area. The base station is further connected to wired networks for facilitating communication traffic beyond the wireless coverage area including, but not limited to, publically accessible networks including the global communications network (i.e., the Internet). A central network access server maintained by a wireless service provider is linked between the base station and the wired networks for implementing and maintaining prepaid remote access services to customers operating the wireless stations.

The wireless stations are adapted to provide the customers with remote communications access to the wired networks typically in the form of a global communications network such as the Internet on a prepaid basis. Preferably, the customers may use their own portable electronic devices as wireless stations to access the system of the present invention. Prior to access, the customers may set up prepaid accounts or balance amounts stored and updated at the central network access server from which an access service charge may be deducted at a predetermined charge rate for the remote access service. The customers may access the system on the condition that a positive prepaid balance amount is maintained in the prepaid account.

The present invention further provides a wireless access network which obtains customer-inputted identification information related to the prepaid account. The information is transmitted to an authentication server through the global communications network for authenticating information to thereby provide authorization to the system. The authentication server reviews the information through a central database containing the prepaid account information of the prepaid card including the prepaid balance amount. Upon authentication, the authentication server provides the customer with authorization for access to and the corresponding charge rates of the remote access services through an authentication client. The authentication client implements the execution of the services and monitors the usage time and the charge rates for the services. Upon termination of the session, the accrued charges are tallied by the authentication client and transmitted to the authentication server whereupon the authorization is canceled. The authorization server subsequently updates the prepaid account information.

In one aspect of the present invention, there is provided a network system for providing a customer with a prepaid wireless remote access service, where the system comprises:

a base station including a wireless access point for communicating through a wireless medium with a wireless station operated by a customer;

a global communications network including a plurality of remote computer servers, the global communications network being connected to the base station; and

a central access server in communication with the base station through the global communications network for providing the customer with the wireless prepaid remote access service from the wireless station to the plurality of remote computer servers.

In another aspect of the present invention there is provided a method for providing a customer with a prepaid wireless remote access service, where the method comprises:

connecting a base station to a wireless station operated by the customer through a wireless communication medium;

querying the customer for authentication information;

authenticating the authentication information provided by the customer;

checking a prepaid balance amount associated with the authentication information; and

enabling wireless remote access service to the customer through the wireless station to a global communication network, upon affirmative authentication and prepaid balance amount check.

### BRIEF DESCRIPTION OF THE DRAWINGS

The following drawings in which like reference characters indicate like parts are illustrative of embodiments of the invention and are not to be construed as limiting the invention as encompassed by the claims forming part of the application.

FIG. 1 is a schematic diagram of a wireless access network for providing a customer with a prepaid wireless remote access service for one embodiment of the present invention.

### DETAILED DESCRIPTION OF THE INVENTION

The present invention is generally directed to a wireless access network system capable of providing prepaid wireless remote access services and method of using the same. The network system is configured for implementing high bandwidth communications links to prepaid customers through a wireless medium at any location within a wireless coverage area. The network system requires minimal space for executing operations over a wide public area without the physical constraints and limitations of hardwiring, connecting ports, and user interface equipment. The manner in which the network system can be implemented and positioned inconspicuously makes the system especially suitable for use in public places with limited space and high traffic throughput such as airports, transportation centers, vehicles, restaurants, libraries, and the like.

In the present invention, there is generally provided a base station in communication with one or more wireless stations comprising, for example, portable electronic devices. The base station is responsible for all the wireless stations within a certain wireless coverage area. The base station is typically connected to additional wired networks for communications beyond the wireless coverage area including, but not limited to, publically accessible networks, a global communications network (i.e., the Internet), and the like. A central network access server maintained by a wireless service provider is linked between the base station and the wired networks for implementing and maintaining prepaid remote access services to customers operating the wireless stations.

Customers with the wireless stations are provided with remote communications access to the wired networks typically in the form of a global communications network such as the Internet on a prepaid basis. Preferably, the customers may use their own portable electronic devices as wireless stations to access the system of the present invention. The system is further adapted to automatically configure the operating system settings of a range of wireless-enabling electronic devices to facilitate access for first time and returning customers. Prior to access, the customers may set up prepaid accounts or balance amounts stored and updated at the central network access server. The customers may access the system on the condition that a positive prepaid balance amount is maintained in the prepaid account. An access service charge is deducted from the balance amounts at a predetermined charge rate for each remote access service session.

The term “stations” refers hereinafter to any device whether active or passive which is capable of communicating in a communications network including, but not limited to, personal computers, servers, routers, personal digital assistants, and the like. The transmitted information may be in the form of data, video, voice, and combinations thereof, commonly referred to as “multimedia”. The term “client” refers to any computer connected to the network that requests services (e.g. files, print capability, authentication, authorization, and the like) from another member of the network.

The term “ethernet” refers to a widely used LAN access method and is defined by the IEEE 802.3 standard. The ethernet network is typically a “shared media LAN” which means that all the devices on the network segment share total bandwidth.

The term “remote access services or applications” refers to services for enabling a customer to get into a server or computer through the global communications network to get data, software and the like from a remote location.

In accordance with a further aspect of the present invention, a prepaid card is provided which suitably includes all the information necessary to allow a customer to draw upon the prepaid balance amount for obtaining remote access service at a wireless station. However, it will be appreciated that the present invention is not so limited. For example, virtually any type of prepaid arrangement may be effected through the use of the system discussed herein, including prepaid goods and services of any kind. In this regard, the goods may relate to data and information which may be sold or accessed through data networks, telephone networks, or global communications networks such as the Internet.

The prepaid card may have printed or stored thereon a suitable identification code or PIN by which the wireless service provider may employ to obtain payment. The prepaid customer can obtain remote access service through the wireless network system operated by the prepaid service provider by inputting the ID code or PIN of the prepaid card into the wireless station. The wireless station connects with the remote central access server to transmit the PIN. The remote central access server searches the prepaid card database residing thereon to determine the balance amount on the prepaid card.

If a sufficient balance amount is present, the prepaid customer is permitted to proceed with the wireless remote access service whereupon the cost for such service is deducted from the balance amount. If the balance amount is inadequate to cover the session, the prepaid customer is notified of the balance amount. The customer is requested to replenish the balance amount of the prepaid card such as by depositing payment with the participating prepaid card vendors or vending terminals. Such vendors or terminals may be operatively associated with the central access server maintained by the wireless service provider. If the balance amount on the prepaid card is prematurely depleted, further sale of the goods or services is suspended until the customer replenishes the balance amount of the prepaid card.

To provide additional security to the customer, the prepaid card may be further associated with a security code such as a password which can be selected or modified by the customer at the time of purchase of the prepaid card or during access to the remote access service. The customer-selected security code is transmitted and securely stored in association with the PIN of the prepaid card on the central database in the remote central access server maintained by the prepaid service provider. The central database may be adapted to store the PINs and the corresponding customer-selected security codes of the activated prepaid cards separately on the database for added security. Thus, to access services offered by the prepaid service provider (i.e., wireless remote access service), the customer is prompted to supply both the PIN and the customer selected security code, before providing the wireless remote access. In this manner, the prepaid customer is protected against use of the prepaid card by unauthorized persons for purchasing goods or services. The prepaid customer may be optionally permitted to change the security code periodically at the wireless station such as by changing the password or by changing the type of code (e.g. from a word to a series of numerals, or alphanumeric strings).

If the prepaid card is lost or stolen, a replacement prepaid card may be issued with the same PIN to the rightful prepaid customer. If the prepaid customer forgets the security code, the customer may contact the prepaid wireless service provider to obtain a new code. The prepaid wireless service provider may verify the prepaid customer's identity such as through conventional verification methods such as by requesting personal information known only to the rightful customer. Upon proper verification, the prepaid customer is provided a new security code for immediate use.

In the context of the present invention set forth herein, the prepaid account corresponds to a prepaid card useful for obtaining wireless remote access services. However, it will be appreciated that the present invention is not so limited, for example, virtually any type of prepaid arrangement or prepayment system may be effected through the use of the system discussed herein. The system may be used to obtain prepaid goods or services of any kind through the global communications network from participating merchants and service providers. In this regard, the goods may relate to data and information which may be sold through data networks, telephone networks, or the Internet.

In an alternative embodiment, the balance amount on the prepaid card may be may be deducted immediately and electronically from a credit card, a debit card, a check card, a charge account, or other forms of remote payment systems. If the balance amount reaches a minimum limit, the wireless service provider may automatically deduct a new charge amount to replenish the balance amount.

The prepaid card is typically a credit-card sized plastic card with identification information printed or stored thereon. The customer may purchase a prepaid card in advance from a participating vendor or a vending machine or terminal. The prepaid card includes a balance amount where charges accrued for wireless remote access services may be deducted therefrom. The balance amount entitles the customer to a specific access amount or time. For example, the balance amount may provide 30 minutes of access time for a specified dollar amount (e.g. $5.00). The prepaid card may be sold with balance amounts in multiple denominations such as $1, $5, $10, $20, $50 or higher, or any customer selected prepayment or debit amounts. The balance amounts may subsequently be renewed by depositing additional debit amounts through the vendor or vending terminal.

A prepaid card or PIN database residing on a remote central billing server stores account information including security/identification codes, usage history, etc., correlated to each prepaid card sold or distributed. The remote central billing server is accessible through the global communications network which enables the vendors and vending terminals to communicate with the remote central billing server to update the PIN database when additional prepayment or debit amounts have been deposited to a prepaid card. Under this prepayment system, the prepaid card customer is permitted access to the multimedia access terminal upon appropriate authorization and clearance from the remote central billing server as will be described hereinafter.

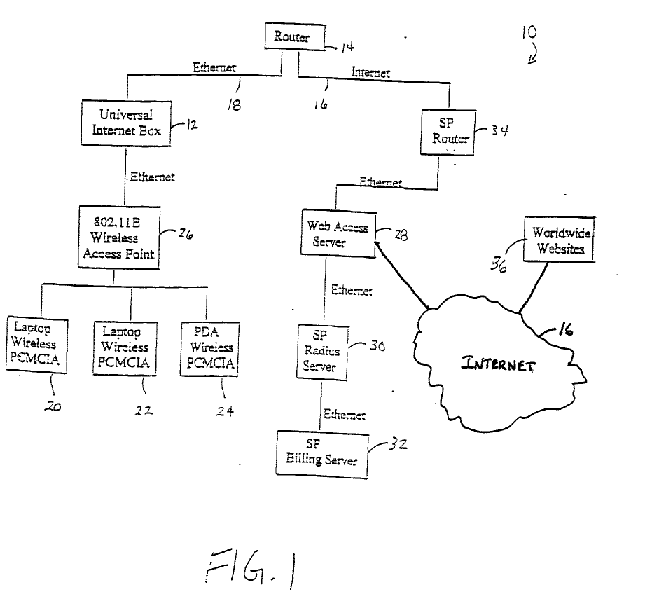

Referring to FIG. 1, a schematic diagram of one embodiment of a prepaid wireless Internet access network 10 is shown. The wireless access network 10 generally includes a base station server or base station 12, a wireless access point 26 for connecting with one or more wireless stations 20, 22 and 24 through a wireless medium such as radio frequency signal, infrared light, laser, and the like, the global communications network 16, and a central billing server 32 with a remote authentication dial-in user service (RADIUS) server 30. The wireless stations 20, 22, and 24 are used by customers to connect to the base station 12 for obtaining prepaid wireless remote access services.

The wireless stations 20,22, and 24 may include any wireless-enabled electronic device that can be used to connect to the base station 12 to remotely access the global communications network such as the Internet including the World Wide Web (WWW) for web browsing and the like. The WWW is a graphical user interface system that facilitates access to information on the Internet by organizing it into pages. WWW also provides hyperlinks, which, when “clicked” with a mouse, downloads the corresponding page located at an IP address that contains the implied information.

The base station 12 provides broadband service network for high speed access to the global communications network 16 (i.e., the Internet). The base station 12 mainly controls and administers local wireless access by one or more customers equipped with the wireless stations 20, 22, and 24. The base station 12 includes a microcontroller comprising an embedded main board with a central processing unit and a flash memory device for controlling the execution of programs, performing data manipulations and controlling the tasks of the hardware components. The base station 12 may be implemented in a variety of environments where multiple customers may obtain high speed access to the global communications network 16 (i.e., the Internet) over a range of IP configurations (e.g. fixed IP, DHCP client, or private IP) on the wireless stations 20, 22, and 24.

The base station 12 is configured to immediately recognize new customers accessing the wireless network 10 as well as repeat customers. Preferably, the customers have access to a browser software program such as Netscape Navigator from Netscape or Internet Explorer from Microsoft installed on the wireless stations. The base station 12 redirects the customer's browser to a proprietary WWW page. The base station 12 automatically re-configures the network configuration settings for wireless remote access to the global communications network. Thus, the base station 12 enables the customer to simply connect the wireless station 20, 22, or 24 in a “plug and play” mode of operation for ease of service. The base station 12 includes multiple ports for connection to the wireless access network 10, and for system management and administration. The base station 12 may be further adapted to permit the wireless service provider to manage the base station 12 through the wireless access network 10.

The base station 12 supports RADIUS client applications for enabling the wireless service provider to maintain the central database of customers and their PINS. RADIUS is an authentication, authorization and accounting system used by remote access service providers for controlling and maintaining access by authorized parties. The RADIUS client operates in conjunction with a RADIUS server to implement the above aims as will be described hereinafter. The base station 12 may be optionally configured to include an authentication server which is programmed to administer the customer's login name and security code (e.g. password). The service provider may further configure the base station 12 to display advertisements through the wireless stations 20, 22, and 24 to the customer.

Other functions executed by the base station 12 includes an address translate function which enables all network configurations to be compatible. Such network configurations include those relating to dynamic host-configuration protocols (DHCP); domain name system (DNS); and dynamic, proxy, and static internet protocol (IP) address assignment settings. Therefore, the base station 12 may automatically translate the network settings of the wireless stations 20, 22, and 24 for seamless access to the global communications network 16.

Further functions executed by the base station 12 include DNS redirection which provides a local DNS server when the customer's DNS server is operating behind a firewall or located on a private intranet; email redirection service; home page redirection for redirecting customers to portal web site to generate advertising revenues and the like; DHCP function for supplying dynamic IP addresses, automating the transmission control protocol/Internet protocol (TCP/IP) client configuration process and maintaining records of the IP addresses to be assigned to the wireless stations; and internal customer management for storing and maintaining a customer account database and prompting the customer to input the PIN and the associated security code. The base station 12 may be integrated into the wireless access network 10 through the implementation of a commercially available device such as the ISS-2000 Internet Subscriber Server manufactured by Handlink Technology, Inc. of Hsinchu, Taiwan, which is capable of providing the above-described functional features.

The wireless stations 20, 22, and 24 are connected to the base station 12 via the wireless communication medium. The portable wireless devices may include mobile and personal computers, personal digital assistants, palmtop computers, handheld personal computers, pen-based computers, handheld scanners and data collectors, handheld printers, and the like. In the present invention, the customers are equipped with wireless-enabled electronic devices which are preferably portable for mobile connection to the wireless access network 10 which encompasses the global communications network 16. The number of portable wireless devices accessible to the wireless access network 10 is unlimited, and may include more than the three devices specifically shown in FIG. 1, depending on the access capacity of the wireless access network 10, particularly the base station 12.

Generally, the portable wireless devices 20, 22, and 24 are connected to the wired portion of the wireless access network 10 through a suitable wireless communications medium such as radio frequency signal, infrared or laser beams, or the like. The portable wireless devices 20, 22, and 24 are each linked to the base station 12 for communicating information therebetween.

Each of the portable wireless devices 20, 22, and 24 further includes a wireless network interface, typically in the form of a wireless network interface card (NIC), which is a commercially known and available device that is purchased and installed by the customer prior to access. The wireless network interface operates to couple the digital signal from the end-user portable wireless device to the wireless medium, to enable an efficient transfer of data between sender and receiver. The wireless interface card interfaces with the portable wireless device 20, 22 or 24, via a computer bus such as Industry Standard Architecture (ISA) or Personal Computer Memory Card International Association (PCMCIA). Many portable computers include PCMCIA slots that accept credit-card size NICs. The wireless interface cards are typically a one-piece unit including a radio and transceiver assembly which is PCMCIA-compatible. There are generally three PCMCIA interface sizes: Type I (3.3 millimeters), Type II (5.0 millimeters), and Type III(10.5 millimeters).

Wireless network interfaces may include any commonly available and known communications interface for a range of wireless communications media. For example, 5 the wireless network interfaces may be infrared transmission interfaces, wherein the wireless communications media comprises an infrared spectrum. Preferably, wireless network interfaces are in compliance with a standard promulgated by the Infrared Data Association (IrDA). Alternatively, the wireless network interfaces may be radio-frequency (RF) communication interfaces wherein the wireless communications medium comprises a radio-frequency spectrum.

The portable wireless devices 20, 22, and 24 are connected to the base station 12 through a wireless access point 26 also referred to as a wireless local bridge. The access point 26 is a hardware device, or software used in conjunction with a computer, that serves as a communications hub for wireless clients or stations, and provides a connection to a wired network (e.g., LAN, WAN). The access point 26 can be adapted to double the range of the wireless stations and provide enhanced security. The connection between the wireless access point 26 and the base station 12 may include any high bandwidth communication channels such as ethernet networks, frame relay networks, synchronous optical network (SONET), asynchronous transfer mode (ATM) networks, digital subscriber loop (xDSL) networks, cable networks, satellite links, T1/T3/E1 trunk lines, integrated services digital network (ISDN), satellite feed lines, digital cable feed lines, and the like for data transfer through a global communications network (i.e., the Internet).

The wireless access point 26 provides an interface between the wireless network interface of the wireless portable device 20, 22, or 24, and the wired portion of the wireless access network 10. In this manner, the wireless network interface forms a data link between the portable wireless device 20, 22 or 24 and the wireless network, and the access point 26 interfaces the wireless network with the wired portion of the wireless access network 10. It is noted that multiple access points and a wired network backbone may be utilized to create a multiple cell configuration for greater connection range. Such a configuration can provide continuous network connectivity when the access area exceeds the range of a single-cell wireless LAN. As a result, a large wireless access area can be provided which allows customers to roam within the access area covered by multiple cells and maintain a live connection to the wireless access network 10.

In the preferred embodiment of the wireless access network 10, the portable wireless devices 20, 22, and 24 and the wireless access point 26 communicates through radio wave transmissions. The wireless network interface and the wireless access point 26 conforms with the Institute of Electrical and Electronics Engineers (IEEE) standard 802.11 and extensions thereof such as IEEE 802.11a and 802.11b for standardizing wireless local area networks (wireless LANs).

The IEEE 802.11 standard provides specifications for a high-speed wireless connection between fixed, portable and moving stations (at pedestrian or vehicular speeds) within a local area. The standard defines the over-the-air interface or protocol that wireless stations will use to talk to each other or to the access points. The protocols specified by IEEE 802.11 are compatible with standard Ethernet protocols, thus making wireless and wired nodes on an enterprise local area network (LAN) virtually indistinguishable. The wireless access point 26 is connected to the base station 12 through an Ethernet network.

In one form of the present invention, the wireless access point 26 and the wireless interface card (not shown) of the wireless stations 20, 22, and 24 may be based on the 802.11b also known as WI-FI. The 802.11B standard operates in the 2.4 GHz band and runs at speeds of about 11 Mbps which is about seven times faster than a T1 connection. The wireless coverage area is typically at least from about 150 to 450 feet from the wireless access point 26. The wireless access point using the 802.11B may be implemented through commercially available devices such as Dell TrueMobile 1150 series AP-1000, and the wireless interface may be implemented by commercially available devices such as Dell TrueMobile 1150 Series Mini-PCI Card and PC card, all manufactured and sold by Dell Computer Corp. of Austin, Tex.

In another form of the present invention, the wireless access point 26 and the wireless interface card (not shown) of the wireless stations 20, 22, and 24 may be based on the 802.11a standard. Products based on the 803.11a operates in the 5 GHz band and runs at speeds of about 54 Mbps. The 802.11a standard products are available from Atheros Communications, Inc. of Sunnyvale, Calif.

In another form of the present invention, the wireless access point 26 and the wireless interface card (not shown) of the wireless stations 20, 22, and 24 may be based on the 802.11g standard which offer data rates at about 54 Mbps in the 2.4 GHz range. The 802.11g standard products are available from Intersil Corp. of Irvine, Calif.

In another form of the present invention, the wireless access point 26 and the wireless interface card (not shown) of the wireless stations 20, 22, and 24 may be based on the Bluetooth standard. The Bluetooth standard offer data rates at about 1 Mbps in the 2.4 GHz range. The Bluetooth standard provides a low-power, short range wireless network with built-in 128-bit encryption for data transfer security through the wireless medium. Bluetooth standard products are available from 3Com of Santa Clara, Calif.

It is understood that the wireless interface is not limited to the IEEE 802.11 standard and Bluetooth, and may also include other open standards for facilitating wireless communications links between various wireless enabled electronic devices such as between the base station and one or more wireless stations.

The wireless access point 26 is equipped with a range of driver types from various software operating systems including, but not limited to, Windows95, Windows 98, Windows NT, Windows2000, Linux, Win CE and the like, to promote accessibility and compatibility with various portable wireless devices. In this manner, the customer is relieved from having to configure respective wireless devices for connection with the wireless access network 10 of the present invention, thus simplifying setup for the customer.

With reference again to FIG. 1, the base station 12 is connected to the global communications networks 16 (i.e., the Internet) through a router 14. The router 14 operates to direct the communications traffic from the base station 12 through the global communications network 16 to a service provider router 34 connected at the other end thereof. The router 14 may be part of the base station 12 or as a separate unit as shown in FIG. 1. The router 14 and the base station 16 are connected via a communications channel 18 such as an ethernet network, for example.

The service provider router 34 receives the communications traffic originating from the base station 12 through the global communications network 16 and transmits it to the web access server 28. The web access server 28 operates as a central gateway to the global communications network 16 with a plurality of WWW destination web servers 36 connected thereto. The web access server 28 is also connected to a Remote Authentication Dial-In User Service (Radius) server 30 and a central billing server 32 maintained by the wireless service provider, via a broadband channel such as an ethernet network, for example. The RADIUS server 30 is an authentication server that is connected to the central billing server 32 via a broadband channel such as an ethernet network, for example. The central billing server 32 includes a PIN database for storing information including account data, customer profiles, customer-selected security codes, prepaid card usage history, schedule of charge rates for the services for the wireless remote access service.

The central billing server 32 maintains and updates the information stored on the PIN database on a periodic basis. The schedule of charge rates is periodically updated by the service provider. The RADIUS server 30 is a client/server-based authentication software system that is used by service providers for implementing remote access applications and maintaining customer profiles in the PIN database residing on the central billing server 32. The RADIUS server 30 can be shared by base stations 12. The RADIUS server 30 is programmed to execute authentication, authorization, and accounting procedures for checking and validating information provided by the customer desiring to access the services. This process is carried out by the RADIUS server 30 for all wireless remote access applications and services.

The central billing server 32, the RADIUS server 30 and an assigned RADIUS client which may be selected from the base station 12, or the web access server 28, in combination perform the accounting, monitoring and maintenance of the wireless remote access services provided to the customer. The RADIUS client is configured to provides the customer access to the global communications network only upon authorization from the RADIUS server 30. The RADIUS server 30 reviews the information provided by the customer and checks it with the central billing server 32 prior to issuing the authorization. Once access is permitted, the service charges incurred by the customer is monitored and tracked by the RADIUS server 30 through the assigned RADIUS client (i.e. the base station 12 or the web access server 28). The resulting charges for usage are deducted from the balance amount according to the prevailing charge rate and the usage time. The updated balance amount is subsequently recorded by the central billing server 86 on the PIN database as will be described herein.

The operation of the wireless access network 10 will now be described herein with reference to FIG. 1. The customer can initiate the wireless remote access service by simply powering up the wireless station 20, 22, or 24, or by opening the browser software or email program residing on the wireless station 20, 22, or 24 within the wireless coverage area of the access point 26. The wireless station 20, 22, or 24 and the base station 16 perform an initial connection set-up or “handshake” part of the connection protocol to exchange information specific to speed, error-detection, and the like. The wireless station 20, 22, or 24 requests the base station 12 to assign an IP address for enabling network recognition. The DHCP server of the base station 12 responds to the request by assigning an IP address to the connecting wireless station 20, 22, or 24. Upon connection, the base station 12 prompts the portable wireless station 20, 22 or 24 to provide a valid PIN number and security code (e.g. password) corresponding to a prepaid card.

Once the PIN and the security code (e.g. password) is furnished by the customer, the base station 12 connects to the web access server 28 maintained by the wireless service provider. The RADIUS server 30 receives an access request from the RADIUS client (i.e., the base station 12 or the web access server 28) for authentication and authorization for access. The access requests contains the PIN and security code of the customer's prepaid card. The RADIUS server 30 carries out the authentication and accounting procedures to ensure that the customer's PIN and security code are correct and valid. The information is authenticated and validated by the RADIUS server 30 through the PIN database residing on the central billing server 32. The RADIUS server 30 then reviews the balance amount on the prepaid card through the PIN database. Upon verification and review of the PIN/security code, and balance amount, the RADIUS server 30 retrieves the corresponding charge rate from the billing schedule stored on the PIN database. The RADIUS server 30 transmits an authorization message including the account information, balance amount, and charge rate to the RADIUS client (i.e. the base station 12 or the web access server 28).

Upon receipt of the authorization message from the RADIUS server 30, the RADIUS client implements the requested service to the customer and tracks the usage time and access charges associated therewith. Once connected for the remote access service, the customer may access any server on the global communications network 16 for downloading or transmitting data, software, and the like from or to the server 36. For WWW system, the wireless access customer may simply enter the prerequisite information such as the IP address or the like, to connect the web access server 28 to the destination server 36 through the global communications network 16. The customer is then connected to the desired destination server 32 to download the requested WWW page.

During the course of customer access, the RADIUS server 30 tracks and monitors the usage time and the access charges and continuously reviews the balance amount remaining through the RADIUS client.

If the balance amount on the prepaid card is low, the customer is informed by the RADIUS client of the low balance amount along with the estimated time remaining for continued access. The customer may choose to replenish the prepaid card at a participating prepaid card vendor or vending terminal. The customer takes the prepaid card to the vendor or vending terminal where payment in the form of a currency, credit card, check card, debit card, or the like may be accepted. Upon receipt of payment from the customer, the vendor or vending terminal is adapted to communicate with the RADIUS server 30 to direct the central billing server 32 to update the balance amount on the prepaid card to reflect the payment received. If, during the access session, the time or balance amount remaining on the customer's prepaid card is depleted, the RADIUS client (i.e., the base station 12, or the web access server 28) may immediately terminate the connection and the remote access service.

At conclusion of the wireless remote access session, the RADIUS client generates a billing report containing detailed information on the access session including the usage time and history, and the total charges based on the charge rate previously transmitted from the RADIUS server 30. Each remote access event (transfer, connect, disconnect, etc.) gets a time stamp. The billing report is transmitted by the RADIUS client to the RADIUS server 30. Upon receipt of the billing report, the RADIUS server 30 withdraws the access authorization to the RADIUS client for terminating access therethrough. The RADIUS server 30 forwards the billing report to the central billing server 32. The central billing server 32 receives the report and deducts the charges from the balance amount. The balance amount on the PIN database is updated to reflect the charges on the billing report. A confirmation is returned to the RADIUS client for display to the customer on the wireless station 20, 22, or 24.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A network system for providing a customer with a prepaid wireless remote access service, said system comprising:
a base station including a wireless access point for communicating through a wireless medium with a wireless station operated by a customer;
a global communications network including a plurality of remote computer servers, said global communications network being connected to said base station; and
a central access server in communication with the base station through the global communications network for providing the customer with the wireless prepaid remote access service from the wireless station to the plurality of remote computer servers.

2. The network system of claim 1 wherein the wireless medium is selected from the group consisting of radio frequency signals, infrared beams and laser beams.

3. The network system of claim 1 wherein the central access server comprises:
a remote access server communicatively connected to the base station for routing access to the plurality of remote computer servers;
a remote authentication dial-in user service (RADIUS) server operatively associated with the remote access server, said RADIUS server adapted for carrying out authentication of the prepaid customer, authorizing the remote access server to route the access upon said authentication, and accounting customer usage of the wireless remote access service; and
a central billing server including a PIN database operatively associated with the RADIUS server, adapted for storing and updating account information associated with the prepaid customer including authentication information and balance amount wherein the RADIUS server configured for accessing the central billing server to carry out said authentication and balance amount check.

4. The network system of claim 3 further comprising a payment acceptor means operatively associated with the central billing server for accepting payment from the prepaid customer and effecting the central billing server to update the account information on the PIN database to reflect the payment accepted.

5. The network system of claim 1 wherein the global communications network is the Internet.

6. The network system of claim 1 wherein the base station is connected to the global communications network through a communications channel selected from the group consisting of ethernet networks, frame relay networks, synchronous optical network (SONET), asynchronous transfer mode (ATM) networks, digital subscriber loop (xDSL) networks, cable networks, satellite links, T1T3/E1 trunk lines, integrated services digital network (ISDN), satellite feed lines, and digital cable feed lines.

7. The network system of claim 1 wherein the wireless access point and the wireless station communicate though the wireless medium via a wireless LAN communications protocol.

8. The network system of claim 7 wherein the wireless LAN communications protocol is based on a wireless protocol standard selected from the group consisting of IEEE 802.11a, IEEE 802.11b, Bluetooth, and IEEE 802.11g.

9. The network system of claim 1 wherein the wireless access point includes a wireless coverage area extending from about 150 feet to 500 feet therefrom.

10. The network system of claim 1 wherein the base station is connected to the global communications network through a network router.

11. A method for providing a customer with a prepaid wireless remote access service, the method comprising:
connecting a base station to a wireless station operated by the customer through a wireless communication medium;
querying the customer for authentication information;
authenticating the authentication information provided by the customer;
checking a prepaid balance amount associated with the authentication information; and
enabling wireless remote access service to said customer through the wireless station to a global communication network, upon affirmative authentication and prepaid balance amount check.

12. The method of claim 11 wherein the authenticating and checking steps are executed by a remote authentication dial-in user service server connected to the base station via the global communications network.

13. The method of claim 11 further comprising accessing a central billing server with a PIN database containing the account information including the authentication information and the prepaid balance amount associated with the customer.

14. The method of claim 12 wherein the enabling step comprises transmitting authorization from the RADIUS server to a remote access server communicatively connected to the base station for routing access to a plurality of remote computer servers via the global communications network.

15. The method of claim 11 comprising monitoring remote access usage by the customer.

16. The method of claim 15 comprising:
deducting charges accrued by the customer from the prepaid balance amount according to the remote access usage; and
updating the new prepaid balance amount.

17. The method of claim 11 wherein the connecting step is executed through a wireless access point.

18. The method of claim 11 further comprising replenishing the prepaid balance amount by electronically drawing on funds from a remote payment system.

19. The method of claim 18 wherein the remote payment system is selected from the group consisting of credit cards, debit cards, checking accounts, charge accounts, savings accounts, and prepaid cards.

20. The method of claim 11 wherein the authentication information includes a personal identification number (PIN) and a corresponding security code.
